(19) United States
(12) Patent Application Publication
(10) Pub. No.: US 2026/0309472 A1
(43) Pub. Date: Oct. 8, 2026

(54) RECHARGEABLE LIGHTED NOCK

(71) Applicant: Shenzhen Wanbang Technology Co., Ltd., Shenzhen (CN)

(72) Inventor: Zhengliang Shu, Shenzhen (CN)

(21) Appl. No.: 19/246,711

(22) Filed: Jun. 24, 2025

(30) Foreign Application Priority Data
Apr. 3, 2025 (CN) 202520627309.7

(51) Int. Cl. F42B 6/06; H01M 50/247

(52) U.S. Cl. CPC F42B 6/06; H01M 50/247; H01M 2220/30

(57) ABSTRACT

Disclosed is a rechargeable lighted nock, including a nock body, a connection housing, and a rechargeable battery, where the nock body and the connection housing are integrally formed, a front end of the rechargeable battery is inserted into the connection housing, a drive core is movably arranged along a front-rear direction inside the connection housing, a side of the drive core is connected to a toggle switch, an LED bead is connected to the drive core, a spring is connected between a negative electrode of the LED bead and a negative electrode of the rechargeable battery, the spring is sleeved on a central column of the rechargeable battery, and a positive electrode of the rechargeable battery is connected to a positive electrode of the LED bead.

### CROSS REFERENCE TO RELATED APPLICATIONS

The present disclosure claims the priority of Chinese Patent Application No. 202520627309.7 filed on Apr. 3, 2025. All the above are hereby incorporated by reference in their entirety.

### TECHNICAL FIELD

The present disclosure relates to the technical field of outdoor sporting goods, and particularly relates to a rechargeable lighted nock.

### BACKGROUND

A bow includes an elastic bow limb and a flexible bowstring, while an arrow includes an arrowhead, an arrow shaft, and an arrow nock. During current outdoor sports or hunting activities, lighted nocks are commonly used in archery activities, because under low-light conditions, the position of the arrow may be tracked via the lighted nock. Conventional lighted nocks employ disposable batteries, which easily cause pollution and waste, and do not facilitate reuse.

### SUMMARY

An objective of the present disclosure is to: provide a rechargeable lighted nock, through the use of a rechargeable battery, reuse a battery structure, save cost resources, and also provide external power distribution capability, enhance reusability of product use.

To achieve the objective, the present disclosure employs the following technical solution:

A rechargeable lighted nock includes a nock body, a connection housing, and a rechargeable battery, wherein the nock body and the connection housing are integrally formed, a front end of the rechargeable battery is inserted into the connection housing, a drive core is movably arranged along a front-rear direction inside the connection housing, a side of the drive core is connected to a toggle switch, an LED bead is connected to the drive core, a spring is connected between a negative electrode of the LED bead and a negative electrode of the rechargeable battery, the spring is sleeved on a central column of the rechargeable battery, and a positive electrode of the rechargeable battery is connected to a positive electrode of the LED bead.

In some implementations, an elastic terminal is mounted in a middle portion of the connection housing, and the elastic terminal presses against the LED bead.

In some implementations, an end of the rechargeable battery away from the LED bead extends out of the connection housing, crimping grooves are provided on an outer side of the rechargeable battery, and a number of the crimping grooves is two.

In some implementations, a PCB board is mounted inside the connection housing, and the PCB board is elastically connected to the spring.

In some implementations, a battery housing is sleeved on an outer side of the rechargeable battery, an internal thread is mounted on an inner sidewall of the battery housing, an external thread is provided on an outer side of the connection housing, and the external thread is engaged with the internal thread.

The beneficial effects of the present disclosure is to provide a rechargeable lighted nock. The rechargeable lighted nock supplies power to the LED bead via elastic contact of the rechargeable battery, the rechargeable battery is able to be recharged when power is insufficient, saving costs, improving reusability of product use, facilitating rapid power supply, the entire lighted nock has a longer service life, and the product is more convenient to use.

### BRIEF DESCRIPTION OF THE DRAWINGS

Hereinafter, the present disclosure is further described in detail with reference to the drawings and embodiments.

FIG. 1 is a schematic perspective view of a rechargeable lighted nock according to Embodiment 1;

FIG. 2 is a first cross-sectional view of the rechargeable lighted nock according to Embodiment 1;

FIG. 3 is a second cross-sectional view of the rechargeable lighted nock according to Embodiment 1;

FIG. 4 is a schematic perspective view of a rechargeable lighted nock according to Embodiment 2;

FIG. 5 is a first cross-sectional view of the rechargeable lighted nock according to Embodiment 2;

FIG. 6 is a second cross-sectional view of the rechargeable lighted nock according to Embodiment 2.

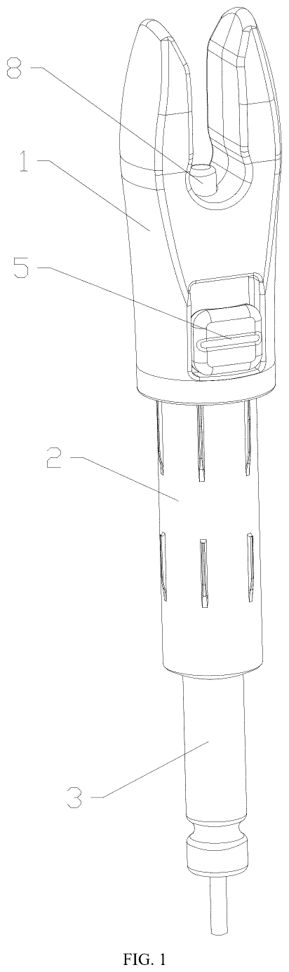

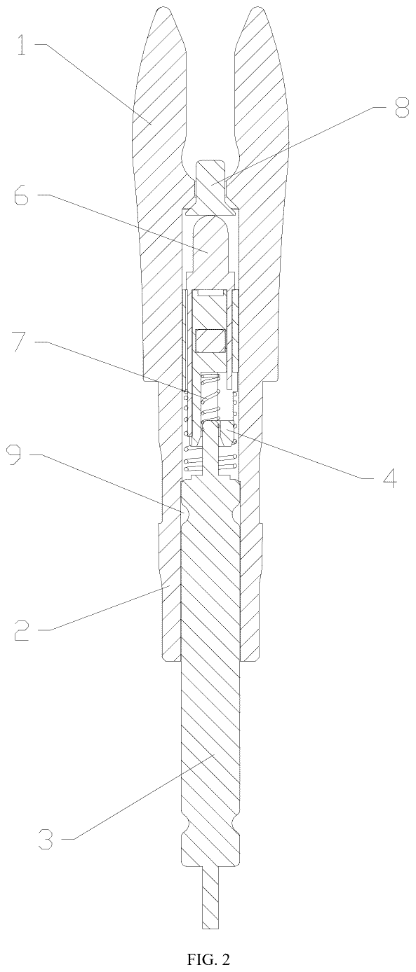

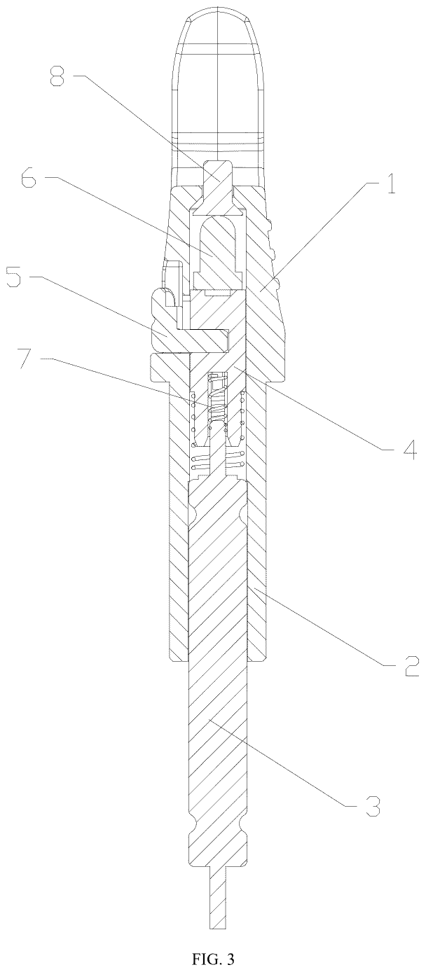

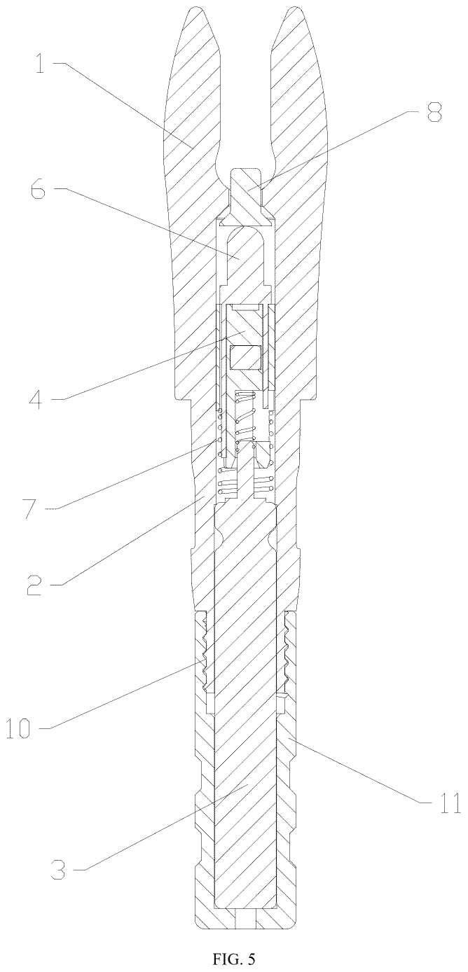

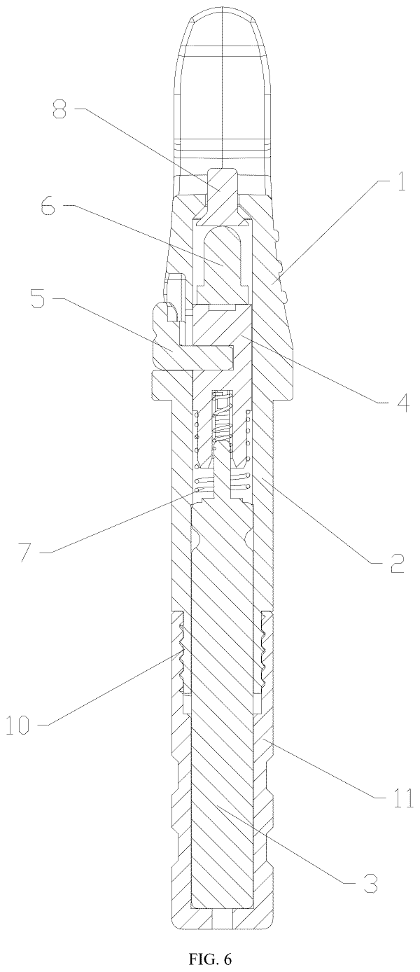

In FIGS. 1 to 6:
1: nock body; 2: connection housing; 3: rechargeable battery; 4: drive core; 5: toggle switch; 6: LED bead; 7: spring; 8: elastic terminal; 9: crimping groove; 10: internal thread; 11: battery housing.

### DETAILED DESCRIPTION

Hereinafter, the technical solution of the present disclosure is further explained with reference to the drawings and specific embodiments.

### Embodiment 1

As shown in FIG. 1 to FIG. 3, in the present embodiment, a rechargeable lighted nock includes a nock body 1, a connection housing 2, and a rechargeable battery 3. The nock body 1 and the connection housing 2 are integrally formed. A front end of the rechargeable battery 3 is inserted into the connection housing 2. A drive core 4 is movably arranged along a front-rear direction inside the connection housing 2. A side of the drive core 4 is connected to a toggle switch 5. An LED bead 6 is connected to the drive core 4. A spring 7 is connected between a negative electrode of the LED bead 6 and a negative electrode of the rechargeable battery 3. The spring 7 is sleeved on a central column of the rechargeable battery 3. A positive electrode of the rechargeable battery 3 is connected to a positive electrode of the LED bead 6.

In the above, the rechargeable battery 3 is fixed integrally with the connection housing 2. The rechargeable battery 3 employed is a pin-type battery. The spring 7 is connected to the rechargeable battery 3 by being sleeved on the central column, resulting in tighter contact. Simultaneously, a side glue cover of the nock body 1 is cancelled, increasing the overall internal strength.

The rechargeable battery 3 is able to distribute power to an external LED light.

An elastic terminal 8 is mounted in a middle portion of the connection housing 2. The elastic terminal 8 presses against the LED bead 6. During a string-drawing process, the elastic terminal 8 is squeezed, moving the LED bead 6 toward the rechargeable battery 3. The spring 7 contracts, connecting the rechargeable battery 3 to the LED bead 6, thereby causing the LED bead 6 to emit light.

An end of the rechargeable battery 3 away from the LED bead 6 extends out of the connection housing 2. Crimping grooves 9 are provided on an outer side of the rechargeable battery 3. A number of the crimping grooves 9 is two. A voltage crimping process is changed from a single groove to double grooves to eliminate the risk of leakage from the rechargeable battery 3.

A PCB board is mounted inside the connection housing 2. The PCB board is elastically connected to the spring 7.

### Embodiment 2

The difference between the present embodiment and Embodiment 1 lies in that the rechargeable battery 3 is detachable.

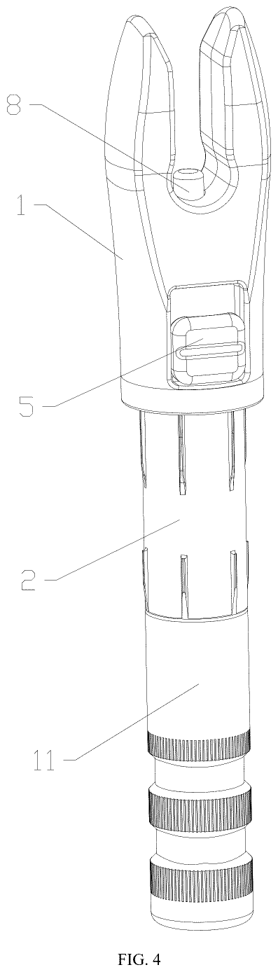

As shown in FIG. 4 to FIG. 6, in the present embodiment, a rechargeable lighted nock, the rechargeable battery 3 and the connection housing 2 are no longer fixedly integral, where a battery housing 11 is sleeved on an outer side of the rechargeable battery 3, an internal thread 10 is mounted on an inner sidewall of the battery housing 11, an external thread is provided on an outer side of the connection housing 2, and the external thread is engaged with the internal thread 10.

By screwing or unscrewing the rechargeable battery 3 in a spiral manner, the rechargeable battery 3 may be separately removed for charging. After charging is completed, the rechargeable battery 3 may be directly reassembled back onto the connection housing 2, or a new rechargeable battery 3 may be directly replaced, enabling quick and convenient connection.

It should be noted that the above specific implementation methods are merely preferred embodiments of the present disclosure and the applied technical principles. Within the technical scope disclosed in the present invention, any variations or substitutions that may be easily conceived by a person skilled in the art should be covered within the protection scope of the present invention.

What is claimed is:

1. A rechargeable lighted nock, comprising a nock body, a connection housing, and a rechargeable battery, wherein the nock body and the connection housing are integrally formed, a front end of the rechargeable battery is inserted into the connection housing, a drive core is movably arranged along a front-rear direction inside the connection housing, a side of the drive core is connected to a toggle switch, an LED bead is connected to the drive core, a spring is connected between a negative electrode of the LED bead and a negative electrode of the rechargeable battery, the spring is sleeved on a central column of the rechargeable battery, and a positive electrode of the rechargeable battery is connected to a positive electrode of the LED bead.

2. The rechargeable lighted nock according to claim 1, wherein an elastic terminal is mounted in a middle portion of the connection housing, and the elastic terminal presses against the LED bead.

3. The rechargeable lighted nock according to claim 1, wherein an end of the rechargeable battery away from the LED bead extends out of the connection housing, crimping grooves are provided on an outer side of the rechargeable battery, and a number of the crimping grooves is two.

4. The rechargeable lighted nock according to claim 1, wherein a PCB board is mounted inside the connection housing, and the PCB board is elastically connected to the spring.

5. The rechargeable lighted nock according to claim 1, wherein a battery housing is sleeved on an outer side of the rechargeable battery, an internal thread is mounted on an inner sidewall of the battery housing, an external thread is provided on an outer side of the connection housing, and the external thread is engaged with the internal thread.
